(19) United States
(12) Patent Application Publication
(10) Pub. No.: US 2025/0207210 A1
(43) Pub. Date: Jun. 26, 2025

(54) PROCESS FOR PREPARING A HYDRAULIC BINDER AND DEVICE FOR CARRYING OUT THE PROCESS

(71) Applicant: Alfred EDLINGER, Bartholomäberg (AT)

(72) Inventor: Alfred EDLINGER, Bartholomäberg (AT)

(21) Appl. No.: 18/848,323

(22) PCT Filed: Mar. 2, 2023
(86) PCT No.: PCT/IB2023/051933

§ 371 Date: Sep. 18, 2024

(30) Foreign Application Priority Data
Mar. 22, 2022 (AT) A 73/2022

(51) Int. Cl. C21B 3/08

(52) U.S. Cl. CPC C21B 3/08; C21B 2400/024; C21B 2400/052

(57) ABSTRACT

A process for preparing a hydraulic binder, wherein a slag melt containing P₂O₅ and iron oxide and further containing CaO and SiO₂ are subjected to a cooling step by adding an oxidizing agent for the iron oxide for granulating the slag melt to form amorphous slag glass.

### CROSS-REFERENCE TO RELATED APPLICATIONS

The present application is a national phase application of PCT Application No. PCT/IB2023/051933, filed Mar. 2, 2023, entitled “PROCESS FOR PREPARING A HYDRAULIC BINDER AND DEVICE FOR CARRYING OUT THE PROCESS”, which claims the benefit of Austrian Patent Application No. A 73/2022, filed Mar. 22, 2022, each of which is incorporated by reference in its entirety.

### BACKGROUND OF THE INVENTION

### 1. Field of the Invention

The present invention relates to a method for producing a hydraulic binder and a device for carrying out the method according to the invention.

### 2. Description of the Related Art

In the slagging of sewage sludge, animal meal, bone meal and similar organic waste materials, which takes place by incineration at temperatures between approximately 1420° C.-1600° C., a homogeneous slag melt is obtained which, in addition to considerable amounts of phosphates, also contains iron species.

A slag melt with undefined further potential reaction partners of a possible redox reaction between phosphates and iron species not only poses a problem with regard to the possible formation of iron phosphides from the phosphates and the iron species, but also makes the economically sensible usability of this slag melt, which occurs in not inconsiderable quantities, appear desirable.

It is therefore the object of the present invention, on the one hand, to render such a slag melt harmless and, on the other hand, to obtain a valuable product therefrom.

### SUMMARY OF THE INVENTION

The present invention therefore provides a method for producing a hydraulic binder, which is characterized in that a slag melt containing P₂O₅ and iron oxide and also containing CaO and SiO₂ with the addition of an oxidizing agent for the iron oxide is subjected to a cooling step for granulating the slag melt to form amorphous slag glass. Previous methods for producing hydraulic binders have not considered slag melts containing phosphates and in particular P₂O₅ together with iron species. In the present invention, however, it was surprisingly found that the addition of an oxidizing agent and the concomitant formation of spinel or magnetite from the iron oxides results in a hydraulic binder which is distinguished by a particularly high hydraulicity and which, mixed together with quicklime, ZnO, soda, water glass, Portland clinker or gypsum, constitutes a valuable hydraulically effective cement component. The iron content of these slags is converted into magnetite by the oxidation process during vitrification.

In the method according to the invention, it is preferred that the slag melt has a P₂O₅ content of 2.5 wt. % to 30 wt. %, preferably 7.5 wt. % to 25 wt. %, more preferably 12.5 wt. % to 20 wt. % and even more preferably 17 wt. % to 19 wt. %. In particular, the method according to the invention uses a slag melt which has a P₂O₅ content of 15.84 wt. % and additionally contains CaO in amounts of 27.28 wt. %, MgO in amounts of 3.08 wt. %, K₂O in amounts of 0.704 wt. %, SiO₂ in amounts of 25.08 wt. %, Al₂O₃ in amounts of 13.2 wt. %, Fe₂O₃ in amounts of 12.2 wt. % and SO₃ in amounts of 1.32 wt. %. Other components may be included.

In order to be able to carry out the cooling step for granulating the slag melt to produce a highly amorphous hydraulic binder as quickly as possible, the method according to a preferred embodiment of the present invention is further developed in that the basicity (CaO wt. %/SiO₂ wt. %) of the slag melt is set to a value of 0.85 to 1.3, in particular to a value of 1.2, before the cooling step by adding a lime carrier or an aluminum carrier. Setting the basicity to a value in this range ensures that the slag melt has a low viscosity, so that it forms as large a surface as possible during the cooling step and thus rapid cooling takes place. This prevents the formation of slag crystals, so that in the best case a completely amorphous product is obtained as a slag glass.

If a slag melt with a particularly high content of P₂O₅ is used to produce a hydraulic binder in the method according to the invention, the method according to a preferred embodiment of the present invention can be improved by adding elemental aluminum to the slag melt before the cooling step, preferably together with aluminum oxide, and/or by adding at least one carbon carrier, preferably lump coke together with coke dust, and by drawing off P₂ and CO formed thereby from the gas phase. The addition of elemental aluminum ensures an aluthermic reduction of the P₂O₅ to gaseous P₂, which can be drawn off from the gas phase and subsequently obtained by condensation. At the same time, the content of Fe₂O₃ is also reduced by the reduction of the Fe₂O₃ to FeO (Fe³⁺→Fe²⁺). In this case, a redox equilibrium is established at a P₂O₅ content of about 3.5 wt. %. In this way, not only is the quality of the hydraulic binder produced by the method according to the invention ensured, but in addition an extremely pure phosphorus species is obtained, which is a valuable raw material. The addition of elemental aluminum is preferably carried out to such an extent that an equilibrium of the proportions by weight between CaO, SiO₂ and Al₂O₃ is achieved in the slag glass formed. At high contents of P₂O₅, ZnO, Zn halides, organic Zn compounds such as Zn formate and/or Zn acetate and/or inorganic Zn compounds are preferably used to obtain high-strength and biocompatible special cements. Without the mentioned addition of Zn species, the slag glass formed can optionally also be used as a fertilizer component with a high content of lime and phosphate.

The aluthermic reduction of the P₂O₅ is decidedly exothermic, and it may therefore be necessary to moderate this reaction in order to avoid excessively high temperatures of the slag melt and possible distortion phenomena. For this reason, it may preferably be provided to add aluminum oxide as a moderator of the aluthermic reduction. In this case, aluminum oxide, as the product of the oxidation of the aluminum used to reduce the phosphorus oxide, is a moderator, and even relatively large amounts of added aluminum oxide do not pose a problem for the quality of the hydraulic binder to be produced by the method according to the invention, since aluminum oxide is known to be readily compatible with cement and significantly increases the early strength of such cements.

When adding carbon carriers, lump coke with high proportions of coke dust is usually used to accelerate the reduction kinetics due to the very high specific surface area of the coke dust. In this case, a high turbulence between the melt and the reducing agent is to be strived for.

According to a preferred embodiment of the present invention, the slag reduction can also be carried out by adding calcium carbide to the slag melt before the cooling step, preferably together with coal dust, and drawing off P₂ and CO formed thereby from the gas phase. The addition of calcium carbide, optionally mixed with coal dust, leads to an exothermic reduction, which can optionally be moderated by coal dust and the simultaneous endothermic carbon reduction. The corresponding oxide content is reduced according to the following reaction equation:

$${P}_{2} {O}_{5} + {CaC}_{2} + 2 C - > CaO + {P}_{2} ( gas ) + 4 CO ( gas )$$

The CaO formed here very advantageously increases the slag basicity (CaO/SiO₂) by direct reaction in the slag melt. FeO in the slag melt also reacts reductively and exothermically with further addition of calcium carbide according to the following equation:

$$3 FeO + {CaC}_{2} - > 3 Fe ( molten ) + CaO + CO ( gas )$$

Here, too, the basicity of the slag melt is increased. The addition of CaC₂ also leads to an optimal desulfurization of the P-gas, since the sulfur compounds are almost completely integrated into the slag melt.

The addition of an Al carrier (skimmings or dross)-calcium carbide mixture is particularly advantageous with regard to the slag end product and in particular its cement properties, since both the basicity and the Al₂O₃ content of the slag can be adjusted in a particularly advantageous manner before the granulation of the slag melt. The addition of coal dust causes a more moderate reduction and reduces the need for expensive calcium carbide.

Alternatively or additionally, according to a preferred embodiment of the present invention, it can be provided that the slag melt is subjected to an electrochemical reduction of P₂O₅ before the cooling step, preferably at an electrode voltage of 16 V to 24 V, and that the P₂ formed thereby is drawn off as cathode gas. As a rule, about 6.8 kWh of electricity per kg of phosphorus is required. When an inert anode is used, O₂ is produced as anode gas; when a graphite anode is used, CO is produced as anode gas.

A combination of the aforementioned reduction processes is also possible within the scope of the present invention. With the aforementioned reduction methods, the target content of residual phosphate and iron oxide of the product slag can be set in an optimally controlled manner in order to obtain a valuable hydraulic binder after the cooling step.

As already mentioned several times, the most complete possible vitrification of the slag melt used as a starting product of the method according to the invention for producing a hydraulic binder is desirable. For this purpose, the method according to the present invention is preferably further developed such that the cooling step consists in dispersing the slag melt in a water bath, the water bath for the slag melt being preferably at a temperature between 80° C. and the boiling point, preferably between 85° C. and the boiling point, more preferably between 90° C. and the boiling point and especially preferably between 95° C. and the boiling point. According to this preferred procedure, the starting slag melt is introduced into a water bath and dispersed as finely divided as possible in the water bath in order to ensure a rapid transfer of heat from the slag melt into the water bath. The above-discussed adjustment of the basicity of the slag melt and the associated reduction of the viscosity are useful here, since a slag melt with basicity values between 0.85 and 1.3 is dispersed, i.e. divided and comminuted, for example by stirring in a water bath by the shear forces occurring during stirring. For particularly rapid cooling, the water bath is preferably kept at elevated temperatures of over 80° C. and the boiling point, so that when the slag melt is introduced, the water immediately evaporates in the water bath, so that the evaporation enthalpy of the water is immediately available for cooling the slag melt, which, as is known, leads to the absorption of particularly large amounts of heat by the water.

Of course, large amounts of water evaporate here, and correspondingly large amounts of vapors form, which is why the method according to the invention is preferably further developed in this context in such a way that vapors from the water bath arising during the cooling step are collected, condensed and fed back to the water bath, the condensation preferably being carried out in the form of an adiabatic compression for the recovery of exergetically usable waste heat from the vapors. In this case, a closed steam circuit can be formed, so that no problematic vapors can escape when carrying out the method according to the invention. According to a preferred embodiment, the condensation takes place in the form of an adiabatic compression for the recovery of waste heat from the vapors. The adiabatic compression of vapors for the recovery of waste heat is known in the art as thermocompression and leads to the heat of condensation of the vapors occurring at a higher temperature level, as a result of which, in contrast to isobaric compression by cooling, a large part of the waste heat of the vapors can also be obtained as sensible heat by heat exchange.

According to a preferred embodiment of the present invention, vapors from the water bath produced during the cooling step are collected, condensed and fed back to the water bath, the vapors being brought to a temperature between 180° C. and 220° C. by compression and the heat of the vapors is used to dry mechanically dewatered sewage sludge. The enthalpy of the resulting vapor steam (100° C., normal pressure) of the boiling water granulation can be raised by means of a vapor compressor (optionally in combination with an adiabatic vapor compression) to the temperature level mentioned and preferably to a temperature level of approximately 210° C. and can advantageously be used particularly economically for the thermal drying of mechanically dewatered sewage sludge with approximately 25% dry matter to approximately 60% dry matter. The preceding addition of CaO to the still wet sewage sludge leads to a presetting of the basicity and expels nitrogen from the sewage sludge in the form of valuable ammonia (NH₃).

In thermocompression, the vapors are compressed from 100° C. and ambient pressure to 400° C. and 13 bar overpressure by means of a steam compressor. For this purpose, 0.164 kWh/kg of vapor compression work is performed. After compression, this high-pressure steam has a heat content of 0.905 kWh/kg, which can be recovered at this temperature by condensation of the steam via heat exchange, e.g. in the form of electricity. At a realistic efficiency of a steam turbine, approximately 0.271 kWh/kg can be produced in the form of electric current. Thus, minus the compression work, about 0.1 kWh/kg of vapors can be exported from this process in the form of electric current. The method according to the invention produces approximately 1100 kg of vapor per ton of slag melt, resulting in an electricity export of 110 kWh/t of slag melt. This results in considerable CO₂ savings in the disposal of the slag melt.

According to a preferred embodiment, an oxygen carrier is used as the oxidizing agent, in particular air, O₂, CO₂, water and/or steam, in the method according to the invention.

In the method according to the invention and in particular in a procedure in which the cooling step is carried out in a water bath and in particular in a water bath which is kept at a temperature between 80° and the boiling point, a microporous slag glass granulated in the form of hollow spheres is obtained which, due to this property, is preferably suitable for further processing in such a way that the granulated slag glass is ground, preferably to particle sizes of less than 80 micrometers. Due to the extremely high porosity, which is increased by the content of P₂O₅ compared to slag glasses containing less or no P₂O₅, the grinding of the granulated slag glass formed in the method according to the invention requires only very little grinding work during grinding and also no adhesion to the grinding tools. It is therefore possible to obtain very small particle sizes from the granulated slag glass with little effort, and preferably particle sizes of less than 80 micrometers. These are very easily compatible with cement and highly reactive in order to further increase the hydraulicity of the hydraulic binder produced according to the invention. This is accompanied by a particularly advantageous early cement strength.

The fact that the very porous slag glass is ground results in a more or less complete separation of the iron components separated by the oxidation step from the rest of the slag, whereby the iron components are obtained as magnetite. This makes it possible to magnetically separate the iron components from the ground slag glass, as corresponds to a preferred embodiment of the present invention.

This magnetite is a high-quality synthetic iron ore and can be used, for example, in smelting to form pig iron, as a sintering aid in clinker production, as an adsorber mass or as a catalyst in ammonia synthesis by the Haber-Bosch method or in the homogeneous water gas shift reaction. In addition, various spinel formers, such as chromium, are incorporated into the magnetite phase, resulting in a high-purity cement component in which heavy metals are hardly found.

The possible sulphur content of the starting slag melt is sulphated by the oxidation process into the amorphous slag glass with the formation of gypsum, which further increases the cement reactivity of the slag glass. The oxidation of sulfur contained in the starting slag melt to sulfates is catalyzed by the magnetite from the iron oxide that is also formed during the oxidation.

The device according to the invention for carrying out the method comprises a granulation chamber with a basin for receiving a water bath, a feed device for the slag melt in the form of an immersion tube reaching into the basin and comprising a rotatably drivable rotor in the basin below the immersion tube to rotate a water bath to form a vortex, and is characterized according to the invention in that the feed device comprises a melt container for the slag melt, which in its base has an opening which is arranged concentrically to the immersion tube and which can be closed by a plunger displaceable in the axial direction relative to the immersion tube.

With the device according to the invention, it is possible to allow the slag melt, containing P₂O₅ and iron oxide as well as further containing CaO and SiO₂ as well as Al₂O₃, to enter the immersion tube through the annular gap formed between the opening concentrically arranged in the base of the melt container for the slag melt and the plunger, displaceable in the axial direction, as the thinnest possible melt cylinder, so that the slag melt already strikes the water bath as a thin layer, which forms a whirl and thus a vortex in the basin below the immersion tube due to the effect of the rotatably drivable rotor, so that the slag melt striking the rotating water bath is immediately divided and thus dispersed in the water bath. In this way, an extremely rapid cooling of the slag melt occurs, so that complete vitrification into amorphous slag glass can be achieved.

For the addition of an oxidizing agent, the device according to the invention is preferably further developed in such a way that a supply line for a gaseous oxidizing agent is guided axially through the plunger. In this way, the oxidizing agent is already introduced into the thin layer of the slag melt in the immersion tube and enters the water bath together with the slag melt and is also dispersed there, so that there is effective oxidation of the starting slag melt and thus the conversion of iron oxides to magnetite or spinel and, optionally, of sulfur oxides to sulfate and thus the formation of gypsum.

The amorphous slag glass has an extremely low density and therefore floats on the vortex of the water bath after discharge from the area of the rotor. To discharge the hydraulic binder formed in the device according to the invention, the device is therefore designed in such a way that the granulation chamber has a discharge area for granulated slag glass downstream of a weir, preferably with a sieve surface for withdrawing vapors into a vapor outlet preferably arranged in the discharge area, as corresponds to a preferred embodiment of the present invention. Alternatively, a hydrocyclone or a pusher centrifuge can also be provided for separating moisture. The rotor can be adjusted with respect to its rotational speed in such a way that the vortex reaches just up to the upper edge of the weir, so that floating slag glass is conveyed over the weir and into the application area adjoining the weir, so that the slag glass can be discharged from the granulation chamber. The sieve surface arranged in the discharge area according to the preferred embodiment allows any moisture and in particular vapors adhering to the slag glass to be drawn off through the sieve surface. A completely dry slag glass is therefore obtained after the sieve surface, which can be removed, for example, by the action of a rotary valve.

According to a preferred embodiment of the present invention, the vapor outlet forms a siphon that interacts with the basin. In this way, the vapor, which condenses in the vapor outlet below the sieve surface, can be returned directly to the water bath.

### BRIEF DESCRIPTION OF THE DRAWINGS

The invention is explained in more detail below with reference to an exemplary embodiment schematically illustrated in the drawing.

FIG. 1 shows a lateral sectional view of the device according to the invention and

FIG. 2 shows a vertical section transverse to the axial direction at the level of the weir and thus at the level of the discharge area from the granulation chamber.

### DETAILED DESCRIPTION

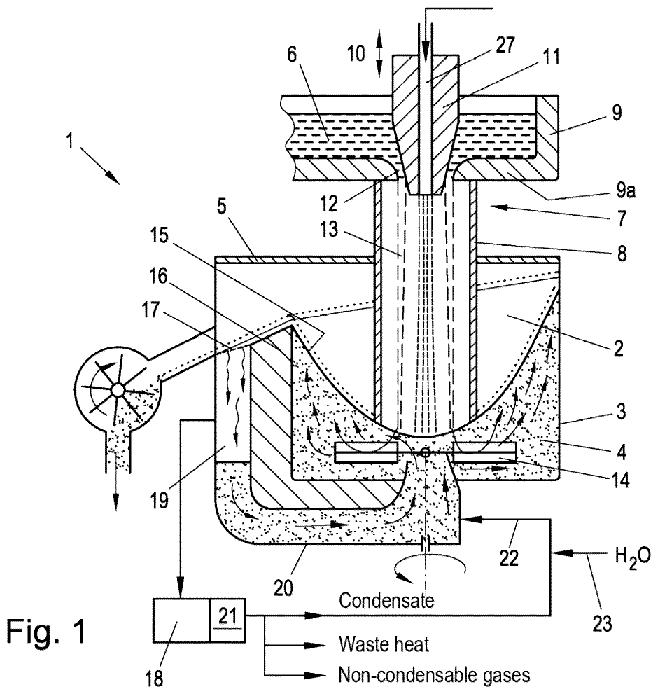

In FIG. 1, the device according to the invention for carrying out the method according to the invention is designated by the reference numeral 1. The device 1 comprises a granulation chamber 2, which forms a basin 3 for receiving a water bath 4. The granulation chamber 2 is closed at an upper end by a cover 5 so that vapors formed during the granulation of the slag melt cannot escape in an uncontrolled manner. A feed device for the slag melt 6 is designated by the reference numeral 7. The feed device 7 consists essentially of an immersion tube 8 extending into the basin 3, a melt container 9 for the melt 6, and a plunger 11 that is displaceable in the axial direction 10 and can close or open an opening 12 arranged in the base 9a of the melt container 9. A supply line 27 for the oxidizing agent is guided axially through the plunger 11. When the opening 12 is opened by the plunger 11, a hollow cylindrical film 13 of the slag melt 6 enters the immersion tube 8 and subsequently strikes the surface of a vortex 15 formed in the water bath 4 by the action of the rotor 14, where it is immediately dispersed and comminuted. In this way, an extremely rapid cooling of the slag melt to form amorphous slag glass takes place in the water bath 4, and the solidified slag glass floats on the surface of the vortex 15. With a corresponding adjustment of the rotational speed of the rotor 14, the slag glass formed reaches the height of the weir 16 and is discharged via the weir 16. During discharge, the slag glass runs over a dewatering device in the form of a sieve surface 17, where vapors can be drawn off directly from the slag glass, the vapors being drawn off from the vapor outlet 19 by the action of a suction fan 18. Any vapors condensing in the vapor outlet 19 are again fed to the water bath through a siphon 20 formed by the vapor outlet 19 and interacting with the water bath 4. The vapor can then be supplied to a compressor 21, in which an adiabatic compression of the vapor takes place, so that condensate can be formed and returned to the water bath 4 via a line 22. Thermocompression also produces waste heat in quantities of approximately 460 kWh/t of initial slag melt. Furthermore, non-condensable gases can be drawn off downstream of the compressor 21. Water can additionally be supplied via a line 23 to compensate for losses in the water bath.

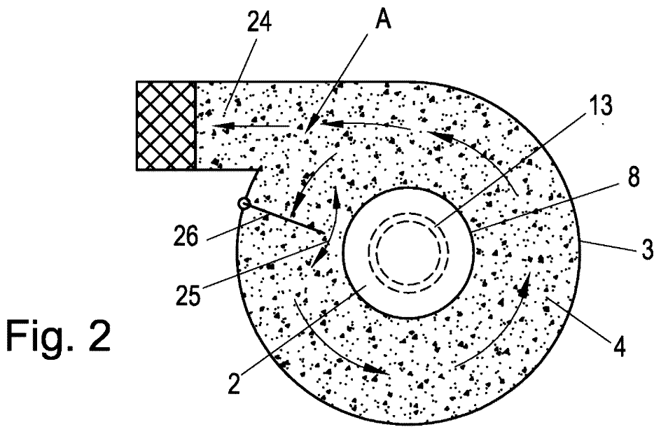

In FIG. 2, the same parts are provided with the same reference numerals, and it can be seen that the granulation chamber 2 has a substantially rotationally symmetrical cross section, which is suitable for forming a vortex by the action of the rotor 14. The amorphous slag glass enters the discharge area 24, which discharges tangentially from the water basin, wherein the weir 15 shown in section in FIG. 1 is arranged in the region marked with the reference numeral A in FIG. 2. In the region of the basin 3, a guide element 26, adjustable in the direction of the double arrow 25, can be arranged downstream of the discharge into the discharge area 24 in the direction of rotation of the vortex 15, indicated by the circularly drawn arrows in FIG. 2, by means of which the slag glass floating on the vortex can be dammed up towards weir 16. For this purpose, the guide element 26 may also be designed in the form of a rake in order not to excessively impede the formation of the vortex 15. A dewatering device in the form of a sieve surface is again provided with the reference numeral 17. As already mentioned, however, the dewatering device can also be designed as a hydrocyclone or as a pusher centrifuge.

1-16. (canceled)

17. A method for producing amorphous slag glass, comprising:
cooling a slag melt containing P₂O₅ and iron oxide, and also containing CaO and SiO₂, and with the addition of an oxidizing agent for the iron oxide, the cooling configured to granulate the slag melt to form amorphous slag glass;
wherein the slag melt has a P₂O₅ content of 7.5 wt. % to 30 wt. %, and in that the slag melt, before the cooling step, is supplemented with elemental aluminum and in that P₂ and CO formed thereby is drawn off from the gas phase.

18. The method according to claim 17, wherein the slag melt has a P₂O₅ content of 12.5 wt. % to 20 wt. %.

19. The method according to claim 18, wherein the slag melt has a P₂O₅ content of 17 wt. % to 19 wt. %.

20. The method according to claim 17, wherein the basicity (CaO wt. %/SiO₂ wt. %) of the slag melt is set to a value of 0.85 to 1.3 before the cooling step by adding a lime carrier or an aluminum carrier.

21. The method according to claim 17, wherein calcium carbide is added to the slag melt before the cooling step, and that P₂ and CO formed thereby is drawn off from the gas phase.

22. The method according to claim 17, wherein the slag melt is subjected to an electrochemical reduction of P₂O₅ before the cooling step and that the P₂ formed thereby is drawn off as cathode gas.

23. The method according to claim 22, wherein the slag melt is subjected to the electrochemical reduction of P₂O₅ at an electrode voltage of 16 V to 24 V.

24. The method according to claim 17, wherein the cooling step consists in dispersing the slag melt in a water bath.

25. The method according to claim 24, wherein the water bath for the slag melt being at a temperature between 80° C. and the boiling point.

26. The method according to claim 23, wherein vapors from the water bath arising during the cooling step are collected, condensed, and fed back to the water bath.

27. The method according to claim 26, wherein, the condensation being carried out in a form of an adiabatic compression for a recovery of waste heat from the vapors.

28. The method according to claim 21, wherein vapors from the water bath produced during the cooling step are collected, condensed, and fed back to the water bath, the vapors being brought to a temperature between 180° C. and 220° C. by compression and the heat of the vapors is used to dry mechanically dewatered sewage sludge.

29. The method according to claim 17, wherein an oxygen carrier is used as the oxidizing agent.

30. The method according to claim 29, wherein the oxygen carrier is at least one of air, O₂, CO₂, water and steam.

31. The method according to claim 17, wherein the granulated slag glass is ground.

32. The method according to claim 31, wherein iron components are magnetically separated from the ground slag glass.

33. A device for producing amorphous slag glass, comprising:
a granulation chamber with a basin and a water bath accommodated therein;
a feed device for the slag melt in the form of an immersion tube reaching into the basin and comprising a rotatably drivable rotor in the basin below the immersion tube to rotate the water bath to form a vortex;
wherein the feed device comprises a melt container for the slag melt, which in its base has an opening arranged concentrically to the immersion tube and configured to be closed by a plunger displaceable in an axial direction relative to the immersion tube;
wherein the slag melt containing P₂O₅ and iron oxide, and also containing CaO and SiO₂, and with the addition of an oxidizing agent for the iron oxide is cooled, the cooling configured to granulate the slag melt to form amorphous slag glass; and
wherein the slag melt has a P₂O₅ content of 7.5 wt. % to 30 wt. %, and in that the slag melt, before the cooling, is supplemented with elemental aluminum and in that P₂ and CO formed thereby is drawn off from the gas phase.

34. The device according to claim 33, wherein a supply line for a gaseous oxidizing agent is guided axially through the plunger.

35. The device according to claim 33, wherein the granulation chamber has a discharge area for granulated slag glass downstream of a weir for withdrawing vapors into a vapor outlet being arranged in the discharge area.

36. The device according to claim 33, wherein the vapor outlet forms a siphon which communicates with the basin.
